(19) United States
(12) Patent Application Publication
(10) Pub. No.: US 2024/0370978 A1
(43) Pub. Date: Nov. 7, 2024

(54) IMAGE PROCESSING APPARATUS THAT COMBINES CAPTURED IMAGE AND CG IMAGE, IMAGE PROCESSING METHOD, AND STORAGE MEDIUM

(71) Applicant: CANON KABUSHIKI KAISHA, Tokyo (JP)

(72) Inventor: HIKARU UCHIDATE, Kanagawa (JP)

(21) Appl. No.: 18/649,754

(22) Filed: Apr. 29, 2024

(30) Foreign Application Priority Data
May 1, 2023 (JP) 2023-075689

(51) Int. Cl. G06T 5/50; G06T 7/20; G06T 7/579

(52) U.S. Cl. CPC G06T 5/50; G06T 7/20; G06T 7/579; G06T 2207/20221

(57) ABSTRACT

An image processing apparatus includes an acquisition unit configured to acquire a captured image obtained by an imaging apparatus capturing a real world, a motion acquisition unit configured to acquire motion information on the imaging apparatus in a space of the real world, a CG generation unit configured to generate a CG image including combining information related to combining with the captured image, based on the motion information on the imaging apparatus, a CG correction unit configured to separate the CG image including the combining information into an image channel and a combining information channel, correct the image channel by pixel interpolation according to the motion information on the imaging apparatus, and correct the combining information channel by pixel replacement according to the motion information on the imaging apparatus, and a combining unit configured to combine the captured image and the CG image corrected by the CG correction unit.

### BACKGROUND OF THE DISCLOSURE

### Field of the Disclosure

The present disclosure relates to an image processing technique for combining a captured image and a computer graphics (CG) image.

### Description of the Related Art

In recent years, a mixed reality (MR) technique has been known as a technique for seamlessly merging a real world and a virtual world in real time. A video see-through type head mounted display (HMD) is known as one of devices that realize the MR technique. The video see-through type HMDs are configured to capture an image of the real world that substantially coincides with an image observed from the pupil position of the HMD user by a video camera or the like and display an MR image obtained by combining the captured image with a computer graphics (CG) image.

The process of generating an MR image by combining a CG image with a captured image is often performed by an external image processing apparatus or the like that is capable of communicating with the HMD. The image processing apparatus receives a captured image captured by a camera of the HMD, calculates the position and orientation of the HMD (the position and orientation of the head of the HMD user) based on the captured image, generates a CG image based on the calculation result, and transmits an MR image obtained by combining the CG image with the captured image to the HMD. That is, the CG image in the MR image generated by the image processing apparatus includes a time delay due to the position and orientation calculation of the HMD, generation processing based on the calculation result, and the like. As a result, when the HMD user views an MR image obtained by combining a CG image including the time delay with a captured image, the HMD user may feel a sense of discomfort in that the CG image is delayed with respect to the captured image.

In contrast, Japanese Patent Application Laid-Open No. 2019-95916 discloses a technique of combining a CG image with a captured image after performing image correction to cancel out a delay of the CG image in accordance with the motion of the head of the HMD user.

When an MR image is generated by combining a CG image with a captured image obtained by capturing the real world, the depth relationship between an object or the like appearing in the captured image and the CG image needs to be correct. However, when image correction for canceling the delay of the CG image is performed as in the technique disclosed in Japanese Patent Laid-Open No. 2019-95916, the depth relationship between the object or the like in the captured image and the CG image may not match, and the image may be uncomfortable for the HMD user.

### SUMMARY OF THE DISCLOSURE

According to an aspect of the present disclosure, an image processing apparatus includes one or more processors, and one or more memories coupled to the one or more processors and storing instructions that, when executed by the one or more processors, cause the processor to function as: an acquisition unit configured to acquire a captured image obtained by an imaging apparatus capturing a real world, a motion acquisition unit configured to acquire motion information on the imaging apparatus in a space of the real world, a computer graphics (CG) generation unit configured to generate a CG image including combining information related to combining with the captured image, based on the motion information on the imaging apparatus, a CG correction unit configured to separate the CG image including the combining information into an image channel and a combining information channel, correct the image channel by pixel interpolation according to the motion information on the imaging apparatus, and correct the combining information channel by pixel replacement according to the motion information on the imaging apparatus, and a combining unit configured to combine the captured image and the CG image corrected by the CG correction unit.

Further features of the present disclosure will become apparent from the following description of exemplary embodiments with reference to the attached drawings.

### BRIEF DESCRIPTION OF THE DRAWINGS

FIG. 1 is a diagram illustrating an example of an overall configuration of a mixed reality (MR) system.

FIG. 2 is a diagram illustrating a detailed configuration example of the MR system according to a first exemplary embodiment.

FIG. 3 is a flowchart of image processing according to the first exemplary embodiment.

FIG. 4 is a diagram illustrating an example of a configuration for correcting a CG image based on a time difference.

FIG. 5 is a flowchart of a process of correcting a CG image based on a time difference.

FIGS. 6A, 6B, and 6C are diagrams illustrating an outline of correction of a CG image based on a time difference.

FIGS. 7A, 7B, and 7C are diagrams illustrating details of correction of a CG image based on a time difference.

FIGS. 8A, 8B, and 8C are diagrams illustrating details of correction of a CG image in the first exemplary embodiment.

FIG. 9 is a diagram illustrating a configuration example of an image processing apparatus according to a second exemplary embodiment.

FIG. 10 is a flowchart of image processing according to the second exemplary embodiment.

### DESCRIPTION OF THE EMBODIMENTS

Hereinafter, exemplary embodiments according to the present disclosure will be described with reference to the drawings. The following exemplary embodiments do not limit the present disclosure, and all combinations of features described in the exemplary embodiments are not necessarily mandatory to the solving means of the present disclosure. The configuration of the exemplary embodiment can be appropriately modified or changed according to the specification and various conditions (use conditions, use environment, and the like) of the apparatus to which the present disclosure is applied. Further, a part of each exemplary embodiment described below may be appropriately combined. In the following exemplary embodiments, the same components are denoted by the same reference numerals.

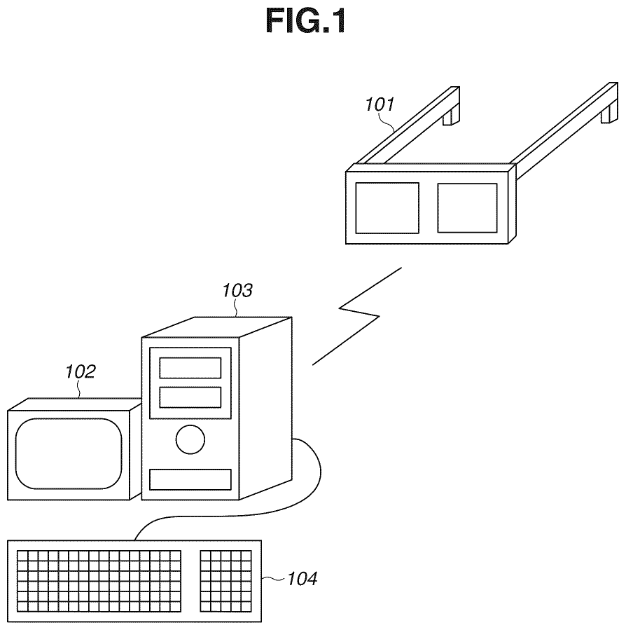

A first exemplary embodiment will be described. FIG. 1 is a diagram illustrating a schematic configuration example of a mixed reality (MR) system according to the first exemplary embodiment.

In FIG. 1, the MR system is configured to include, for example, a head mounted display (HMD) 101 worn on the head of a user, and an image processing apparatus 103 including a display device 102 and an operation unit 104. Hereinafter, the user wearing the HMD 101 on the head is referred to as an HMD user.

The HMD 101 may be a video see-through type HMD. The HMD 101 transmits a captured image obtained by capturing the real world that substantially matches the image observed from the pupil position of the HMD user by an imaging apparatus such as a video camera to the image processing apparatus 103. The image processing apparatus 103 calculates the position and orientation of the HMD 101, that is, the position and orientation of the head of the HMD user based on the captured image received from the HMD 101, and generates a computer graphics (CG) image based on the calculation result. The image processing apparatus 103 generates an MR image by combining the CG image with the captured image, and transmits the MR image to the HMD 101. In the HMD 101, the MR image received from the image processing apparatus 103 is presented so that the user can view the MR image. This allows the HMD user to experience the MR space.

Communication between the HMD 101 and the image processing apparatus 103 may be wireless or wired.

Wireless communication is performed by wireless connection via a small-scale network such as a wireless local area network (WLAN) or a wireless personal area network (WPAN). In the example of FIG. 1, the image processing apparatus 103 and the HMD 101 are configured as separate hardware components, but the HMD 101 and the image processing apparatus 103 may be integrated by implementing all the functions of the image processing apparatus 103 in the HMD 101.

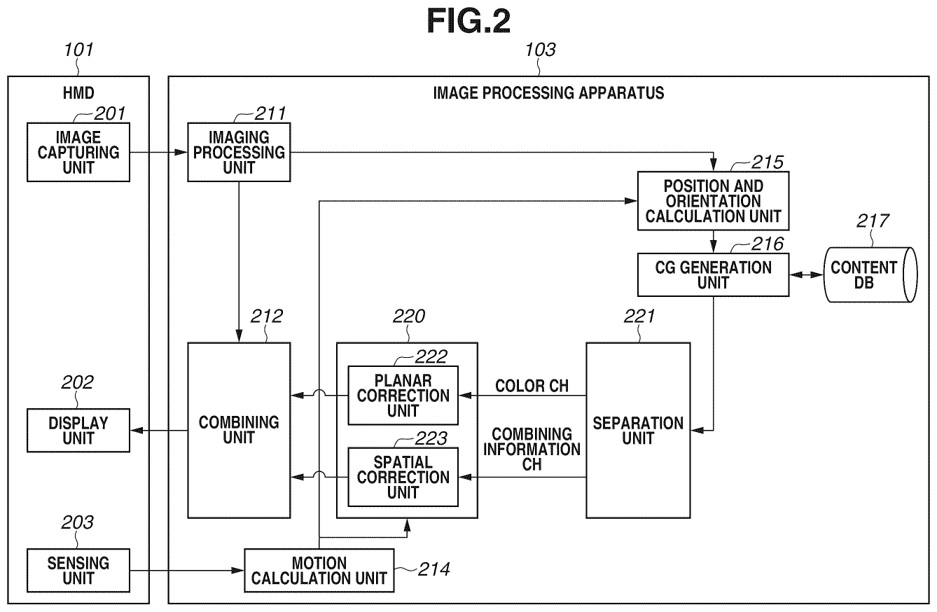

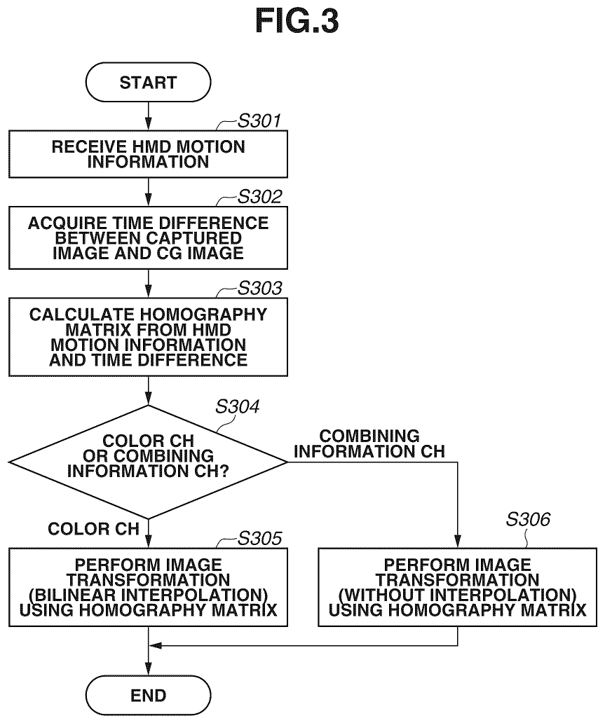

FIG. 2 is a diagram illustrating the main functional parts of the HMD 101 and the image processing apparatus 103 according to the first exemplary embodiment of the MR system illustrated in FIG. 1. FIG. 3 is a flowchart illustrating the flow of processing in the image processing apparatus 103 according to the first exemplary embodiment.

In the HMD 101, an image capturing unit 201 captures an image of the real world (external world). The image capturing unit 201 includes an objective optical system, an image sensor, and the like for imaging the real world (external world).

A display unit 202 is a presentation device for presenting an image to the HMD user, and includes an eyepiece optical system, a display, and the like. The display unit 202 presents an image transmitted from the image processing apparatus 103, which will be described below, to the HMD user. The display unit 202 may be a retinal scan type presentation device using micro electro mechanical systems (MEMS), for example.

A sensing unit 203 senses movements of the HMD 101 in the space of the real world. The sensing unit 203 includes, for example, an inertial measurement unit (IMU), an acceleration sensor, an angular velocity sensor, and the like as a sensor that senses movements of the HMD 101. In the present exemplary embodiment, the sensor of the sensing unit 203 is an IMU.

In the image processing apparatus 103, an imaging processing unit 211 performs imaging processing on a captured image obtained by capturing the real world (external world) by the image capturing unit 201. Here, the imaging processing executed by the imaging processing unit 211 includes demosaicing processing, shading correction, noise reduction, distortion correction, and the like, and is processing for transforming the captured image from the image capturing unit 201 into an image corresponding to human visual characteristics. The image that has undergone the imaging processing by the imaging processing unit 211 is sent to each of a combining unit 212 and a position and orientation calculation unit 215.

A motion calculation unit 214 is a motion acquisition unit that obtains motion information on the image capturing unit 201 in the HMD 101 in the space of the real world, that is, motion information (hereinafter, referred to as HMD motion information) on the head of the HMD user, based on the sensing information from the sensing unit 203. The motion calculation unit 214 calculates information such as movement, inclination, and rotation of the HMD 101 as HMD motion information in the space of the real world, based on the sensing information transmitted from the IMU of the sensing unit 203. Then, the motion calculation unit 214 transmits the calculated HMD motion information to the position and orientation calculation unit 215 and a correction unit 220 to be described below.

The position and orientation calculation unit 215 is a position and orientation acquisition unit that obtains the position and orientation of the HMD 101 in the space of the real world, that is, the position and orientation of the head of the HMD user, based on the image obtained after the imaging processing by the imaging processing unit 211 and the HMD motion information from the motion calculation unit 214. First, the position and orientation calculation unit 215 calculates the relationship between world coordinate system indicating real world and camera coordinate system in the image captured by the image capturing unit 201 of the HMD 101, based on the developed captured image and the HMD motion information. Then, the position and orientation calculation unit 215 calculates the position and orientation of the HMD 101 with respect to the real world, based on the relationship between the world coordinate system and the camera coordinate system.

As a method for calculating the position and orientation of the HMD 101, for example, a method can be used in which a marker or the like serving as a reference is placed on the real world, an image is acquired by the image capturing unit 201 having a stereo camera configuration, and the position and orientation are calculated from the positional relationship with respect to the marker in the captured image. As the position and orientation calculation method, a method of calculating the position and orientation of the HMD 101 by using an external sensor or the like that constantly monitors where the HMD 101 is located in the world coordinate system without using the stereo camera may be used. Detailed configurations and descriptions for realizing these position and orientation calculation methods will be omitted. In the present exemplary embodiment, any of these position and orientation calculation methods may be used, and there is no particular limitation.

The position and orientation information on the HMD calculated by the position and orientation calculation unit 215 is sent to a CG generation unit 216.

A content database (DB) 217 stores data on CG content on which a CG image will be based.

The CG generation unit 216 reads CG content from the content DB 217 based on the position and orientation information from the position and orientation calculation unit 215, and generates a CG image based on the CG content. First, the CG generation unit 216 calculates at which position and in which orientation the CG image is to be superimposed in the captured image, based on the position and orientation information calculated by the position and orientation calculation unit 215. The CG generation unit 216 reads, from the content DB 217, the CG content for generating a CG image having the calculated position and orientation, and renders the CG image. The CG image generated by the CG generation unit 216 is sent to a separation unit 221 constituting a CG correction unit to be described below.

The separation unit 221 separates the CG image generated by the CG generation unit 216 into a color channel (color CH) which is color information on the image and data on a channel (combining information CH) which is combining information described below. The details of the combining information and the channel separation processing in the separation unit 221 will be described below. The data on the color CH and the combining information CH separated by the separation unit 221 is sent to the correction unit 220 constituting the CG correction unit together with the separation unit 221.

The correction unit 220 corrects the data on the color CH and the combining information CH separated by the separation unit 221, based on the HMD motion information calculated by the motion calculation unit 214. The correction processing in the correction unit 220 will be described in detail below. The data on the color CH and the combining information CH corrected by the correction unit 220 is transmitted to the combining unit 212.

The combining unit 212 generates a CG image (corrected CG image) from the image obtained after the imaging processing by the imaging processing unit 211 and the data on the color CH and the combining information CH obtained after the correction by the correction unit 220 to be described below. Further, the combining unit 212 combines the corrected CG image with the image obtained after the imaging processing by the imaging processing unit 211 to generate a combined image (MR image). The combined image (MR image) obtained by the combining unit 212 is sent to and displayed on the display unit 202 in the HMD 101.

This allows the user of the HMD 101 to experience MR.

Before describing the separation unit 221 and the correction unit 220 according to the present exemplary embodiment and the flowchart of FIG. 3, a time difference that occurs between the captured image by the image capturing unit 201 of the HMD 101 and the CG image generated by the CG generation unit 216 will be described.

As described above, the CG generation unit 216 generates a CG image based on the image obtained after the development processing by the imaging processing unit 211 and the position and orientation information calculated by the position and orientation calculation unit 215 using the HMD motion information calculated by the motion calculation unit 214.

However, the processing load in the CG generation unit 216 greatly varies depending on the CG image to be generated. For example, when the processing load is large and it takes time to render a CG image, there may be a temporal mismatch between a captured image obtained by capturing the real world and the rendered CG image. Since the combined image (MR image) viewed by the HMD user is an image obtained by combining the captured image of the real world and the CG image, if there is a temporal mismatch between the captured image and the CG image, the combined image may give a sense of discomfort to the HMD user.

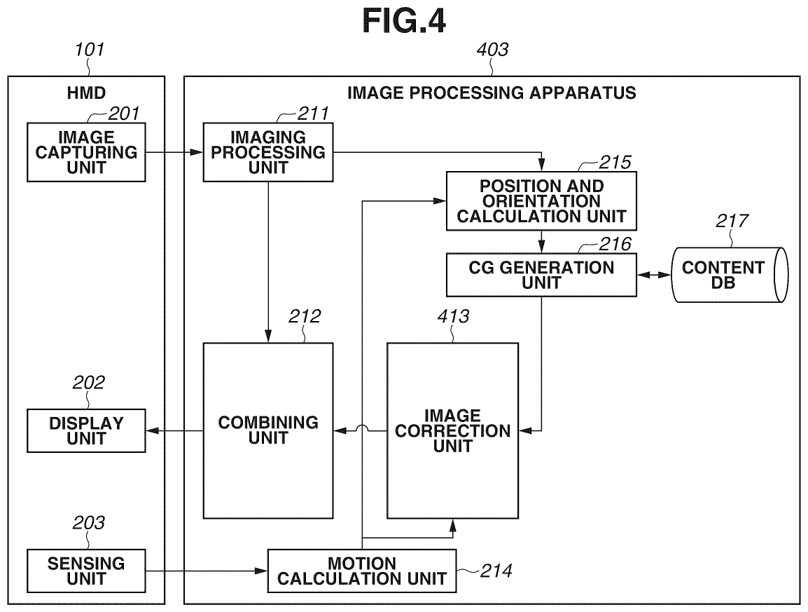

Hereinafter, a configuration and processing as an example in which a time difference between a captured image and a CG image is corrected and a combined image with less sense of discomfort can be generated will be described with reference to FIG. 4 to FIGS. 7A to 7C.

FIG. 4 is a diagram illustrating a configuration example of an MR system including an image processing apparatus 403 as an example capable of generating a combined image with less sense of discomfort in consideration of a time difference between a captured image and a CG image. The image processing apparatus 403 illustrated in FIG. 4 does not include the separation unit 221 and the correction unit 220 of the image processing apparatus 103 according to the first exemplary embodiment illustrated in FIG. 2, but includes an image correction unit 413 instead. In the configuration example of FIG. 4, the same reference numerals as those in FIG. 2 denote constituent elements which perform almost the same processes as those in FIG. 2, and a detailed description thereof will be omitted.

The image correction unit 413 in FIG. 4 performs image correction processing on the CG image generated by the CG generation unit 216, based on the time difference between the captured image and the CG image, thereby generating a CG image that can eliminate a sense of discomfort in the combined image due to temporal mismatch between the captured image and the CG image.

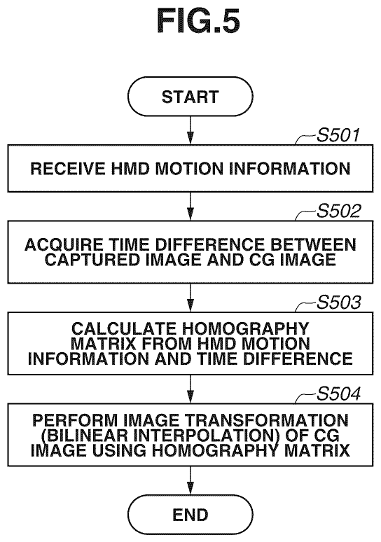

FIG. 5 is a flowchart illustrating the flow of the image correction processing in the image correction unit 413. In the following flowcharts, the symbol S represents a processing step.

First, as the processing of step S501, the image correction unit 413 receives the above-described HMD motion information such as the movement, the inclination, and the rotation of the HMD 101 from the motion calculation unit 214.

Next, in step S502, the image correction unit 413 acquires a time difference between the captured image and the CG image. For example, the image correction unit 413 sets the average time required for rendering of the CG image as a fixed delay value, and acquires the time difference between the fixed delay amount and the captured image. Alternatively, the image correction unit 413 sets the time required for rendering of the CG image as the variable delay amount, and acquires the time difference between the variable delay amount and the captured image. Note that these time difference acquisition methods are merely examples, and the present disclosure is not particularly limited thereto.

Next, in step S503, the image correction unit 413 calculates a position to which the CG image is to be moved with respect to the captured image, based on the HMD motion information obtained in step S501 and the time difference information obtained in the S502, and calculates a homography matrix corresponding to the position of the movement destination.

Then, the image correction unit 413 performs, as the processing in step S504, image conversion by homography transformation using the homography matrix calculated in the S503, and performs correction processing on the CG image. As a method of the correction processing at this time, for example, a method such as bilinear interpolation may be used.

The image correction unit 413 performs processing as in the flowchart of FIG. 5 to match the appearance of the CG image with the captured image. The CG image corrected by the image correction unit 413 is sent to the combining unit 212, and is combined with the captured image as described above to generate a combined image.

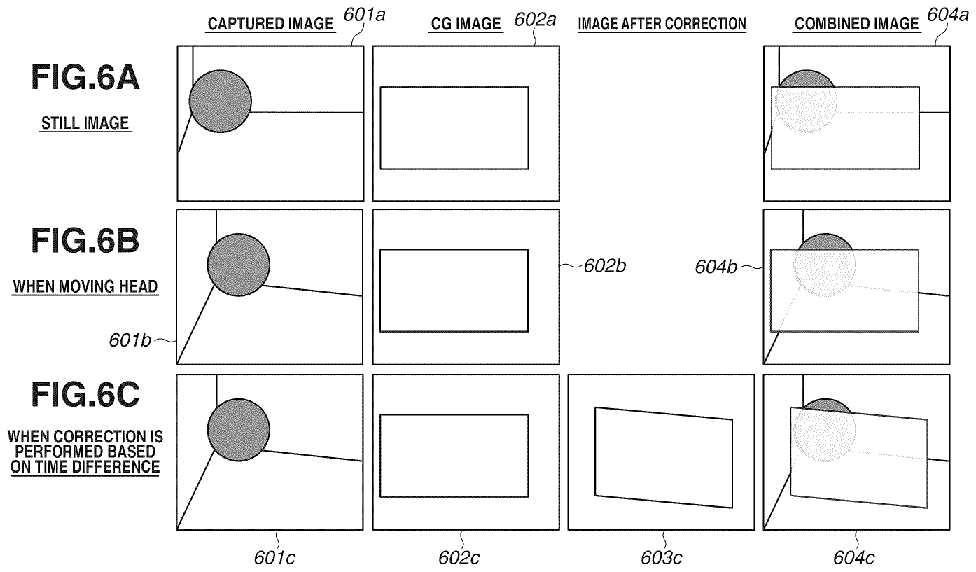

FIGS. 6A, 6B, and 6C are diagrams used for describing the effect of reducing the sense of discomfort in a combined image due to temporal mismatch between a captured image and a CG image and the sense of discomfort in a combined image generated using a CG image obtained after the image correction processing by the image correction unit 413 described above.

FIGS. 6A to 6C illustrate captured images obtained by capturing the real world, CG images generated by the CG generation unit 216, CG images (hereinafter, referred to as a corrected CG image) obtained after image correction by the image correction unit 413, and combined images obtained by combining the captured image and the corrected CG image. FIG. 6A shows an example of a captured image 601a, a CG image 602a, and a combined image 604a obtained by combining the captured image 601a and the CG image 602a in a case where the HMD 101 is in a stationary state, for example.

FIG. 6B shows an image example of a captured image 601b, a CG image 602b, and a combined image 604b obtained by combining the captured image 601b and the CG image 602b in a case where the user shakes his/her head, for example. FIG. 6C shows an image example of a captured image 601c and a CG image 602c similar to those in FIG. 6B, a corrected CG image 603c, and a combined image 604c obtained by combining the captured image 601c and the corrected CG image 603c. Note that the captured image is an image obtained by capturing an image of a sphere placed on the real world, for example, the CG image is a rectangular image, for example, and the combined image is an image in which a part of the sphere of the captured image is covered with the CG image.

As in the example of FIG. 6A, in a case where the HMD 101 is in a stationary state, even if there is a temporal mismatch between the captured image 601a and the CG image 602a, the combined image 604a does not cause a sense of discomfort in appearance at the drawing position of the CG image with respect to the real world captured image. On the other hand, in a case where the user shakes his/her head as in the example in FIG. 6B, the CG image 602b is delayed by the rendering time with respect to the captured image 601b, and thus the drawing position of the CG image with respect to the captured image of the real world is shifted in the combined image 604b. That is, the HMD user feels a sense of discomfort because the position of the CG image of the actual combined image is shifted from the CG image the user should see when the user shakes his or her head.

In contrast, the image correction unit 413 performs the image correction processing on the CG image 602c so that the CG image 602c temporally matches the captured image 601c in accordance with the movement of the HMD 101 as described above. That is, in the image correction processing by the image correction unit 413, as shown in FIG. 6C, the CG image 602c is corrected so as to match the change in the captured image 601c due to the head shake of the user, and the corrected CG image 603c is obtained. Thus, even when the captured image 601c and the CG image 602c do not match temporally, the combined image 604c obtained by combining the corrected CG image 603c is an image that does not give a sense of discomfort to the user.

However, when a captured image obtained by capturing the real world is combined with a CG image obtained after the above-described image correction processing is performed, the depth relationship between an object appearing in the captured image and the CG image may not match. When the depth relationship between the object appearing in the captured image and the CG image does not match, the HMD user feels a sense of discomfort in the image.

Hereinafter, an example of a case where the depth relationship between the object included in the captured image and the CG image does not match due to the image correction processing performed by the image correction unit 413 will be described.

As described above, in a case where a CG image is combined with a captured image obtained by capturing the real world to generate a combined image, the depth relationship between an object appearing in the captured image and the CG image needs to be correct. Therefore, the imaging processing unit 211 also acquires depth information on the real world corresponding to the captured image by the image capturing unit 201. As a method of acquiring depth information corresponding to a captured image, for example, a method of acquiring depth information based on a time difference from irradiation of laser light to obtaining of reflected light, which is called light detection and ranging (LiDAR), can be exemplified. In addition, there is a method of acquiring depth information from a parallax image using a stereo camera. Detailed configurations and descriptions for realizing these depth information acquisition methods are omitted. Any of these depth information acquisition methods may be used, and the method is not particularly limited.

The CG generation unit 216 generates a CG image including the combining information based on the CG content read from the content DB 217. The combining information is information related to combining of the captured image and the CG image, and in this example, includes information on the alpha channel and information on the depth channel, and is used as additional information on the CG image. The information on the alpha channel is transparency information indicating transparency, and the information on the depth channel is depth information.

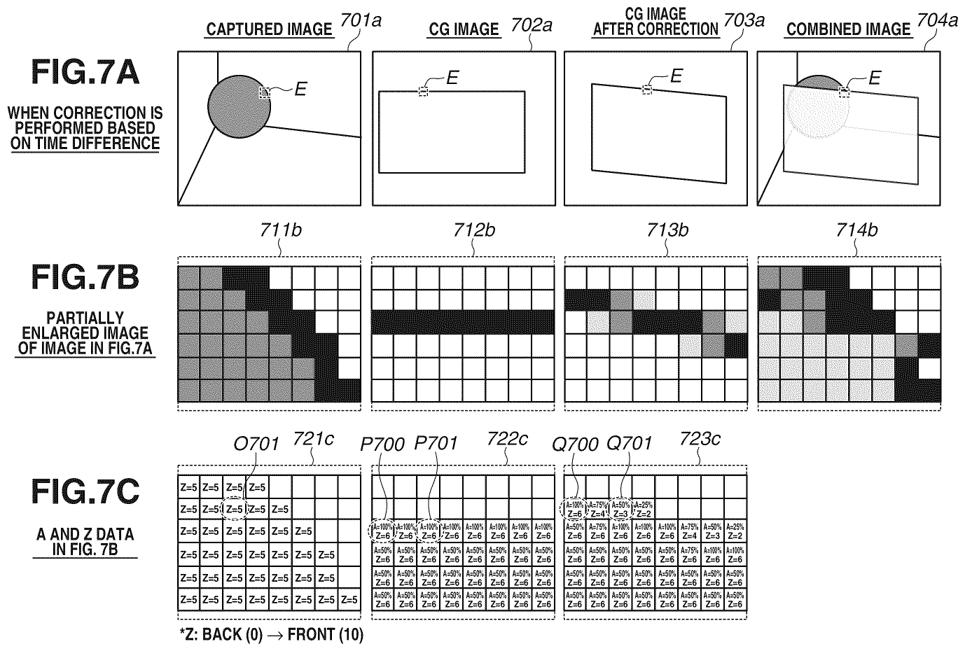

FIGS. 7A, 7B, and 7C are diagrams illustrating an example of a case where a CG image including an alpha channel and a depth channel is corrected by an image correction unit 413 of FIG. 4 described above and then combined with a captured image to generate a combined image. FIG. 7A shows a captured image 701a, a CG image 702a, a corrected CG image 703a, and a combined image 704a obtained by combining the captured image 701a and the corrected CG image 703a, which are the same as those in the example of FIG. 6A. In FIG. 7A, as in the example of FIG. 6A, the captured image 701a is an image obtained by capturing an image of a sphere placed on the real world, the CG image 702a is a rectangular image, and the combined image 704a is an image in which a part of the sphere in the captured image is covered with the CG image.

The difference between FIG. 7A and FIG. 6C is that the CG image 702a includes an alpha channel and a depth channel. Note that, as described above, depth information on the real world is acquired for the captured image 701a. In addition, enlarged images 711b to 714b of respective regions E in FIG. 7A are shown in FIG. 7B, and examples of data 721c to 723c of the values A and Z of the enlarged images 711b to 713b for each pixel in FIG. 7B are shown in FIG. 7C.

The value A of the alpha channel for each pixel shown in FIG. 7C is a value representing the transmittance, and a value between 0% and 100% is used. For example, when A=0%, it represents the CG image in a transparent state (the CG image is 0% and the captured image is 100%), and when A=100%, it represents the CG image in a mask state (the CG image is 100% and the captured image is 0%). In the case of representing a translucent state, for example, by setting A=25%, it is possible to represent a state in which the CG image is translucent (the CG image is 25% and the captured image is 75%).

The value Z of the depth channel for each pixel is a value representing depth information, and a value between 0 and 10 is used. For example, Z=0 indicates the boundary of the rear clip plane in the CG rendering space, and Z=10 indicates the boundary of the front clip plane in the CG rendering space. That is, when Z=0, the depth information in the space represents the deepest position, and when Z=10, the depth information in the space represents the closest position. By changing the value Z of the depth channel between 0 and 10, it is possible to express depth information in a space even on a two dimensional image. Note that the depth information acquired for the captured image is also represented as a value Z, similarly to the depth channel. In this example, the value A of the alpha channel and the value Z of the depth channel have been described as above, but the information clipping method is not particularly limited.

Here, in the enlarged image 711b in FIG. 7B obtained by enlarging the region E of the boundary portion of the sphere in the captured image 701a in FIG. 7A, the value Z of depth information corresponding to each pixel is a value such as that shown in FIG. 7C. In other words, it is assumed that the depth information on the boundary portion of the sphere and the inside of the sphere of the captured image 701a is all Z=5.

For the sake of simplicity, depth information on a region other than the sphere in the captured image 701a is omitted.

In the enlarged image 712b in FIG. 7B obtained by enlarging the region E of the boundary portion of the rectangular CG image 702a FIG. 7A, the value A of the alpha channel and the value Z of the depth channel for each pixel are assumed to be values as shown in FIG. 7C. In the example in FIG. 7C, it is assumed that the value Z of the depth channel of each pixel in the rectangular CG image 702a is Z=6. On the other hand, the value A of the alpha channel of each pixel is A=100% (the CG image is 100% and the captured image is 0%) in the edge portion which is the boundary with the captured image, whereas the value A is A=50% (the CG image is 50% and the captured image is also 50%) inside the edge portion. Note that the values of the alpha channel and depth channel do not exist in regions other than the rectangular CG image.

In this way, in a case where the value Z of the CG image 702a is 6 and the value Z of the sphere of the captured image 701a is 5, the rectangular CG image 702a is arranged on the front side of the sphere of the captured image 701a. Further, in the case of the example of FIG. 7A, since the value A of the edge portion of the CG image 702a is 100%, the captured image is masked by 100% in the edge portion, and on the other hand, since the value A of the inner side of the edge portion is 50%, the captured image is seen through at the inner side of the edge portion. That is, from the viewpoint of the HMD user, the CG image is arranged on the front side of the sphere, and the sphere behind the CG image is seen through.

For example, when the HMD user shakes his/her head, the image correction unit 413 performs image correction processing such as homography transformation using the above-described homography matrix on the rectangular CG image 702a in accordance with the movement of the HMD 101. That is, the image correction unit 413 performs homography transformation on the CG image 702a in accordance with the motion of the HMD 101 to generate the corrected CG image 703a. However, at this time, in terms of the value A of the alpha channel and the value Z of the depth channel, original values of the value A (information on the transparency) and the value Z (depth information) may be lost due to the influence of the homography transformation.

This will be described using the CG image 702a, the enlarged image 712b, and the data 722c before being subjected to the homography transformation and the corrected CG image 703a, the enlarged image 713b, and the data 723c obtained after the homography transformation in FIGS. 7A, 7B, and 7C.

For example, when the homography transformation is performed on the rectangular CG image 702a in FIG. 7A in accordance with the movement of the HMD 101 when the HMD user shakes his/her head, the rectangular CG image 702a is deformed into a parallelogram CG image 703a. That is, when the homography transformation is performed, the edge portion of the rectangular CG image 702a is transformed from a straight line as in the enlarged image 712b to a smoothed oblique line as in the enlarged image 713b. The smoothing processing for smoothing such oblique lines is realized by interpolating pixel data from peripheral pixels of the edge portion, and is a general image correction processing. However, at this time, in the pixel of the edge portion of the corrected CG image 703a, the value A and the value Z of the peripheral pixel are also interpolated in the smoothing processing at the time of transformation from the straight line to the oblique line, and information on original values of the value A and the value Z may be lost.

For example, pixels P700 and P701 of the edge portion of the CG image 702a before being subjected to the homography transformation and the corresponding pixels Q700 and Q701 of the CG image 703a obtained after the homography transformation will be described. The value A of the alpha channel of the pixels P700 and P701 is 100%, and the value Z of the depth channel is 6. The positions of the pixels P700 and P701 move to the positions of the pixels Q700 and Q701 after the edge portion is transformed from a straight line to an oblique line by the homography transformation.

Here, in terms of the pixel P700, since the pixel position is only moved by the homography transformation, the value A of the pixel Q700 and the value Z of the pixel P700 are maintained at 100% and 6, respectively, and thus no problem occurs.

On the other hand, in terms of the pixel P701, the value A of the pixel Q701 changes to 50% and the value Z changes to 3 due to the interpolation processing from the peripheral pixels by the smoothing processing in addition to the movement of the pixel position by the homography transformation. That is, in the pixel Q701, particularly, the value Z of the depth channel is changed to 3, and thus the value Z of the depth information on the pixel Q701 is smaller than 5, which is the value Z of depth information on the captured image 701a. In this case, since the pixels of the captured image 701a are on the front side, when the corrected CG image 703a is combined with the captured image 701a, pixels O701 of the captured image 701a at the positions corresponding to the pixels Q701 of the corrected CG image 703a are arranged on the front side. That is, in the corrected CG image 703a, the front-rear relationship in the depth direction which should be held is reversed, and the pixel Q701 is buried, so that the combined image becomes inappropriate.

As described above, when correction processing is performed on a CG image in consideration of a time difference between a captured image and the CG image, the depth relationship between an object or the like appearing in the captured image and the CG image may not be matched, and a combined image may be inappropriate.

### <Configuration and Processing for Image Correction According to First Exemplary Embodiment>

The image processing apparatus 103 according to the present exemplary embodiment illustrated in FIG. 2 separates the CG image into the color channel and the combining information channel including the alpha channel and the depth channel described above, and performs different image correction processes for each channel. That is, the image processing apparatus 103 according to the first exemplary embodiment illustrated in FIG. 2 includes a CG correction unit including the separation unit 221 and the correction unit 220 instead of the image correction unit 413 described with reference to FIG. 4.

In the image processing apparatus 103 according to the present exemplary embodiment, the CG generation unit 216 generates a CG image including the combining information on the alpha channel and the depth channel as described above. Hereinafter, this CG image is referred to as a CG image with combining information. The CG image with combining information is sent to the separation unit 221.

The separation unit 221 separates the CG image with combining information into a color channel (color CH) which is color information on an image and a combining information channel (combining information CH) including an alpha channel and a depth channel. The color CH is input to a planar correction unit 222 of the correction unit 220, and the combining information CH is input to a spatial correction unit 223 of the correction unit 220.

Hereinafter, processing performed by the planar correction unit 222 and the spatial correction unit 223 of the correction unit 220 will be described with reference to the flowchart of FIG. 3. The processes of steps S301 to S303 in the flowchart of FIG. 3 are executed in common by the planar correction unit 222 and the spatial correction unit 223.

First, in step S301, the planar correction unit 222 and the spatial correction unit 223 acquire the above-described HMD motion information calculated by the motion calculation unit 214.

Next, in step S302, the planar correction unit 222 and the spatial correction unit 223 acquire the above-described time difference between the captured image and the CG image.

Next, in step S303, the planar correction unit 222 and the spatial correction unit 223 calculate the position to which the CG image is to be moved, based on the HMD motion information acquired in step S301 and the information on the time difference acquired in step S302. Then, the planar correction unit 222 and the spatial correction unit 223 calculate a homography matrix corresponding to the destination.

Next, in step S304, the correction unit 220 branches the processing between the color CH and the combining information CH. That is, the correction unit 220 advances the processing to step S305 in the case of the color CH, and advances the processing to step S306 in the case of the combining information CG.

When the processing proceeds to step S305, the planar correction unit 222 performs image correction (image transformation) processing on the color CH of the CG image using the homography matrix calculated in step S303. At this time, the color CH of the CG image needs to be matched with the captured image following the motion of the HMD 101 in a planar manner. Accordingly, the planar correction unit 222 calculates coordinate information from the homography matrix with accuracy after a decimal point as transformed coordinates, and executes image correction by pixel interpolation such as bilinear interpolation using the transformed coordinates as reference pixel positions. That is, the image correction by pixel interpolation in the planar correction unit 222 is correction processing in which color information at the reference pixel position is referred to, and a value obtained by smoothing the color information based on the reference pixel position is used as a correction value for pixel interpolation.

On the other hand, when the processing proceeds to step S306, the spatial correction unit 223 performs image correction (image transformation) on the combining information CH (alpha channel and depth channel) of the CG image using the homography matrix calculated in step S303. At this time, the interpolation processing or the like as described above is not executed for the value A of the alpha channel and the value Z of the depth channel, and the pixel replacement is performed so as to spatially match the captured image. That is, the spatial correction unit 223 performs image correction without interpolation processing, based on the reference pixel position calculated from the homography matrix in the same manner as described above. In the image correction without interpolation processing in the spatial correction unit 223, for example, the combining information on the combining information CH corresponding to the reference pixel position is used as the correction value for pixel replacement. Note that as the correction value for pixel replacement, any of the minimum value, intermediate value, maximum value, and neighboring value of the combining information corresponding to the reference pixel position may be used.

As described above, the image processing apparatus 103 according to the present exemplary embodiment separates a CG image into a color CH and a combining information CH including an alpha channel and a depth channel, and performs different image correction processing for each channel.

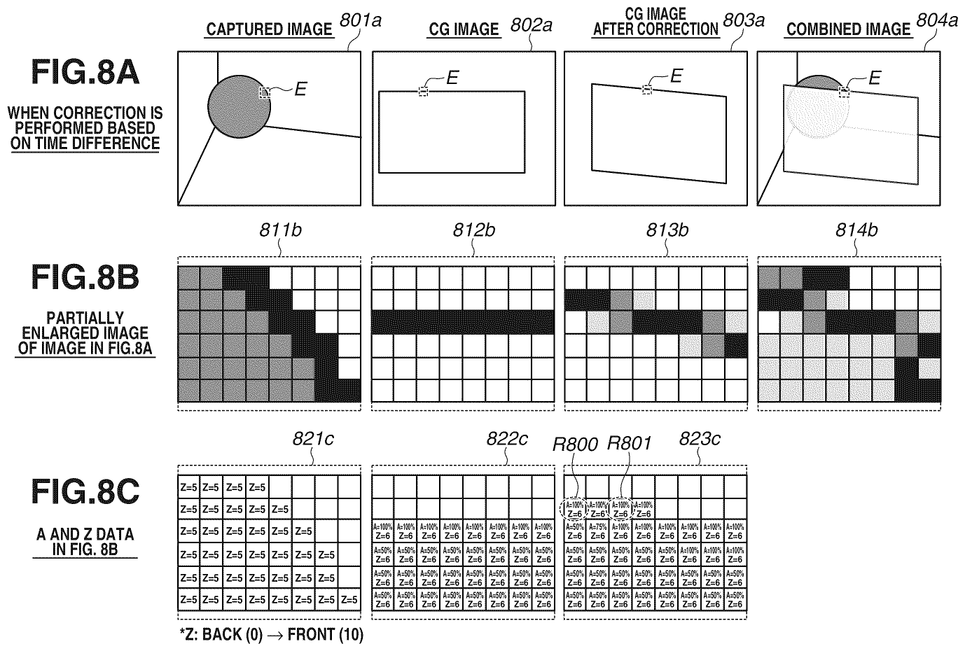

Hereinafter, an effect of the image processing apparatus 103 according to the present exemplary embodiment will be described with reference to FIG. 8.

FIGS. 8A to 8C are diagrams illustrating an example in which the image correction processing is executed on the CG image separately for the color CH and the combining information CH as described above, and the corrected CG image and the captured image are combined to generate the combined image. In the same manner as the example of FIG. 7A, FIG. 8A shows a captured image 801a, a CG image 802a, a corrected CG image 803a according to the present exemplary embodiment, and a combined image 804a obtained by combining the captured image 801a and the corrected CG image 803a. The captured image 801a and the CG image 802a in FIG. 8A are the same images as the captured image 701a and the CG image 702a in FIG. 7A. Enlarged images 811b and 812b in FIG. 8B are similar to the enlarged images 711b and 712b in FIG. 7B, and data 821c and 822c in FIG. 8C are similar to the data 721c and 722c in FIG. 7C.

The corrected CG image 803a in FIG. 8A and an enlarged image 813b in FIG. 8B are CG images obtained after the image correction for only the color CH is performed by the planar correction unit 222 described above. In addition, the edge portions of the corrected CG image 803a and the enlarged image 813b are smoothly corrected by the smoothing processing, as in the example of the corrected CG image 703a and the enlarged image 713b in FIGS. 7A and 7B.

Data 823c in FIG. 8C indicates the value A and the value Z for each pixel obtained after the spatial correction unit 223 performs the image correction processing on the combining information CH (the alpha channel and the depth channel). In the case of the present exemplary embodiment, the spatial correction unit 223 performs image correction without interpolation processing from the reference pixel positions calculated from the homography matrix, and therefore the value A and the value Z of each pixel obtained after the image correction with respect to the combining information CH are as shown by the data 823c.

In data 723c in FIG. 7C described above, the value A of the pixel Q701 changes to 50% and the value Z changes to 3 by the interpolation processing in the smoothing processing, and particularly, the value Z changes from the original value, and as a result, the front-rear relationship between the captured image and the CG image is reversed in the pixel. In contrast, in the configuration of FIG. 2, the color CH and the combining information CH (the alpha channel and the depth channel) are separated, and the interpolation processing is not performed on the combining information CH. Therefore, the values A and Z of pixels R800 and R801 of the data 823c in FIG. 8C corresponding to the pixels Q700 and Q701 of the data 723c in FIG. 7C are held at the original values. In particular, the image correction is performed with the pixel R801 holding information on the value A being 100% and the value Z being 6.

Therefore, the combined image 804a (enlarged image 814b) obtained by combining the captured image 801a and the corrected CG image 803a by the combining unit 212 is an appropriate combined image in which the front-rear relationship in the depth direction to be held is correct.

As described above, in the image processing apparatus 103 according to the first exemplary embodiment, when image correction is performed, a CG image is separated into a color CH and a combining information CH, and different image correction processes are performed on the color CH and the combining information CH, respectively, so that the CG image can be appropriately corrected and combined with a captured image. Therefore, according to the present exemplary embodiment, it is possible to provide an image that does not give a sense of discomfort to the HMD user.

Note that, in the above description, an example in which the captured image is masked when the value A of the alpha channel is 100% is given, but a channel of mask information (mask channel) may be used separately from the alpha channel. That is, in the present exemplary embodiment, an example in which the combining information CH includes two channels of the alpha channel and the depth channel has been described, but the combining information CH may include three channels of the alpha channel, the depth channel, and the mask channel. In addition, the combining information CH may include at least one of the alpha channel, the depth channel, and the mask channel.

In the first exemplary embodiment described above, an example has been given in which, in image correction for resolving temporal mismatch between a captured image and a CG image including an alpha channel and a depth channel, the CG image is separated into a color CH and a combining information CH, and the color CH and the combining information CH are corrected independently.

In the second exemplary embodiment, an example will be described in which image correction is performed on a captured image captured by the image capturing unit 201 in addition to image correction on a CG image similar to that in the first exemplary embodiment. Note that image correction for a CG image is performed by a CG correction unit including the separation unit 221 and correction unit 220, which are similar to those in the first exemplary embodiment, and a description thereof will be omitted.

The HMD user who experiences MR using the HMD 101 visually recognizes the captured image captured by the image capturing unit 201 as an image of the real world. However, the captured image visually recognized by the HMD user is an image obtained after the photoelectric conversion or the like is performed in the image capturing unit 201 and the imaging processing (demosaic processing, shading correction, noise reduction, distortion correction, or the like) is further performed in the imaging processing unit 211. That is, the captured image visually recognized by the HMD user is an image including an electrical conversion time such as photoelectric conversion and a delay time due to the imaging process, and the delay time reaches several 10 ms. That is, there is a temporal mismatch between the real world and the captured image visually recognized by the user. As a result, for example, when the user shakes his/her head quickly, the image visually recognized by the user is an image which is delayed by the delay time and which gives a sense of discomfort, compared to the appearance when the user directly views the real world without using the HMD 101.

Therefore, in an image processing apparatus 903 according to the second exemplary embodiment, image correction for correcting temporal mismatch between the real world and the captured image can also be executed on the captured image, based on the HMD motion information calculated by the motion calculation unit 214.

However, in a case where the captured image includes depth information, when image correction for correcting temporal mismatch between the real world and the captured image is executed on the captured image, the depth information that should be held may change. When the depth information to be held changes, the front-rear relationship in the depth direction between the captured image and the CG image combined by the combining unit 212 may be reversed, and the combined image may give a sense of discomfort.

Thus, the image processing apparatus 903 according to the second exemplary embodiment separates the captured image including the depth information into a color channel (color CH) of the image and a channel (hereinafter, depth CH) of the depth information, and performs independent image correction processing on each of the color channel and the depth channel.

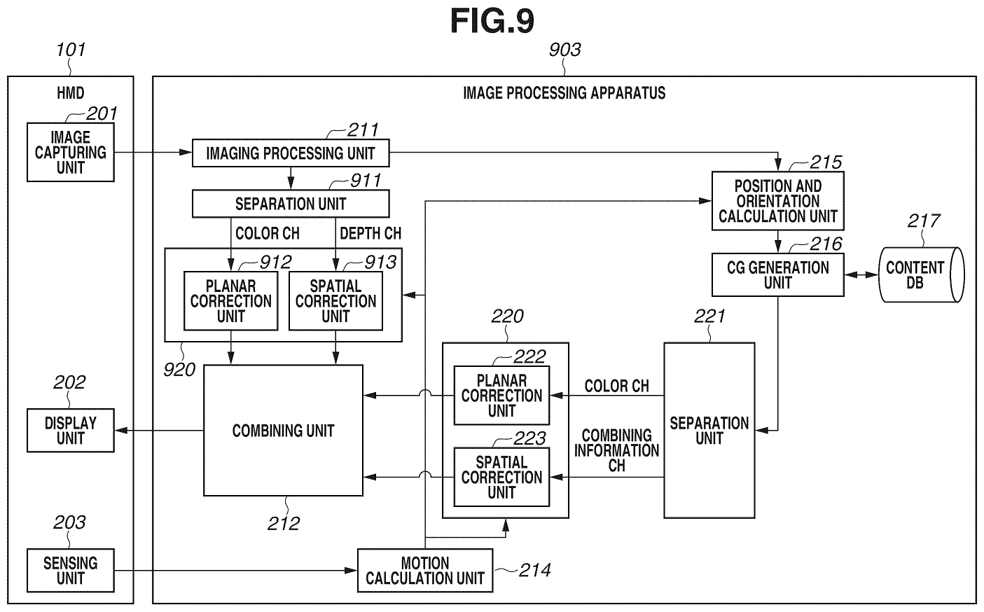

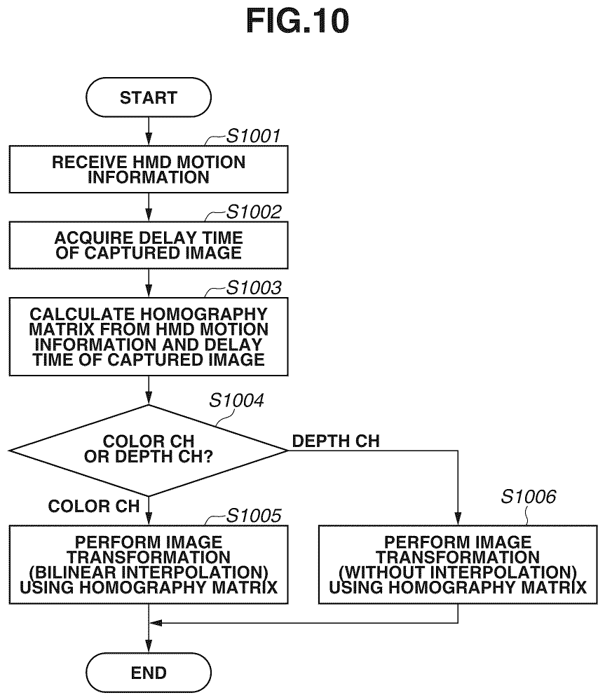

FIG. 9 is a diagram illustrating the main functional units of the HMD 101 of the MR system and the image processing apparatus 903 according to the second exemplary embodiment. In FIG. 9, the same functional units as those in FIG. 2 are denoted by the same reference numerals as those in FIG. 2, and the description thereof will be omitted as appropriate. FIG. 10 is a flowchart illustrating the flow of processing in the image processing apparatus 903 according to the second exemplary embodiment.

As illustrated in FIG. 9, the image processing apparatus 903 according to the second exemplary embodiment further includes a separation unit 911 and a correction unit 920 as a captured image correction unit in addition to the functional units of the image processing apparatus 103 as illustrated in FIG. 2.

The separation unit 911 separates the captured image obtained after the development processing by the imaging processing unit 211 into a color CH and a depth CH. The color CH separated by the separation unit 911 is input to a planar correction unit 912 of the correction unit 920, and the depth CH is input to a spatial correction unit 913 of the correction unit 920.

Hereinafter, processing performed by the planar correction unit 912 and the spatial correction unit 913 of the correction unit 920 will be described with reference to the flowchart of FIG. 10. The processes of steps S1001 to S1003 in the flowchart of FIG. 10 are executed in common by the planar correction unit 912 and the spatial correction unit 913.

First, in step S1001, the planar correction unit 912 and the spatial correction unit 913 acquire the above-described HMD motion information calculated by the motion calculation unit 214.

Next, in step S1002, the planar correction unit 912 and the spatial correction unit 913 acquire a delay time included in the captured image, that is, a delay time due to an electrical conversion time by photoelectric conversion or the like in the image capturing unit 201 and an imaging processing time in the imaging processing unit 211.

Next, in step S1003, the planar correction unit 912 and the spatial correction unit 913 calculate the position to which the captured image is to be moved, based on the HMD motion information acquired in step S1001 and the information on the delay time acquired in step S1002. Then, the planar correction unit 912 and the spatial correction unit 913 calculate a homography matrix corresponding to the destination.

Next, in step S1004, the correction unit 920 branches the processing between the color CH and the depth CH. That is, the correction unit 920 advances the processing to step S1005 in the case of the color CH, and advances the processing to step S1006 in the case of the depth CH.

When the processing proceeds to step S1005, the planar correction unit 912 performs an image correction processing on the color CH of the captured image using the homography matrix calculated in step S1003. At this time, since the color CH of the captured image needs to move the captured image by the delay time, the planar correction unit 912 performs image correction by pixel interpolation such as bilinear interpolation from the reference pixel position calculated from the homography matrix.

On the other hand, when the processing proceeds to step S1006, the spatial correction unit 913 corrects the depth CH of the captured image using the homography matrix calculated in step S1003. At this time, the interpolation processing or the like is not executed for the depth CH, and the pixel replacement is performed so as to spatially match the captured image. That is, the spatial correction unit 913 performs correction processing using depth information corresponding to the reference pixel position calculated from the homography matrix as a correction value for pixel replacement. In other words, the spatial correction unit 913 performs image correction without interpolation processing according to the reference pixel position calculated from the homography matrix.

Thereafter, the combining unit 212 combines the captured image obtained after the image correction and the CG image obtained after the image correction as described above. In the second exemplary embodiment, the CG image is corrected to eliminate the temporal mismatch with the captured image, as described in the first exemplary embodiment. A combined image obtained by combining the captured image and the CG image obtained after the image correction is respectively performed in this manner is sent to the HMD 101 to be displayed on the display unit 202. Thus, the combined image displayed on the display unit 202 can be displayed as an image in which the temporal mismatch with the real world is eliminated for both the captured image and the CG image.

As described above, in the second exemplary embodiment, in addition to the correction of the CG image as in the first exemplary embodiment, the captured image including the depth information is separated into the color CH and the depth CH, and different image correction processes are performed on the color CH and the depth CH. This makes it possible to provide the HMD user with a combined image obtained by combining a captured image and a CG image whose temporal mismatch has been appropriately corrected, that is, to provide the HMD user with an MR experience without a sense of discomfort.

In the second exemplary embodiment, an example is given in which both image correction on a captured image and image correction on a CG image similar to that in the first exemplary embodiment are performed. However, if no time difference occurs between the captured image and the CG image, and the image correction corresponding to the time difference for the CG image as described above is not necessary, only the image correction for the captured image may be performed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-075689, filed May 1, 2023, which is hereby incorporated by reference herein in its entirety.

What is claimed is:

1. An image processing apparatus comprising:
one or more processors; and
one or more memories coupled to the one or more processors and storing instructions that, when executed by the one or more processors, cause the processor to function as:
an acquisition unit configured to acquire a captured image obtained by an imaging apparatus capturing a real world;
a motion acquisition unit configured to acquire motion information on the imaging apparatus in a space of the real world;
a computer graphics (CG) generation unit configured to generate a CG image including combining information related to combining with the captured image, based on the motion information on the imaging apparatus;
a CG correction unit configured to separate the CG image including the combining information into an image channel and a combining information channel, correct the image channel by pixel interpolation according to the motion information on the imaging apparatus, and correct the combining information channel by pixel replacement according to the motion information on the imaging apparatus; and
a combining unit configured to combine the captured image and the CG image corrected by the CG correction unit.

2. The image processing apparatus according to claim 1,
wherein the acquisition unit further acquires depth information on the real world corresponding to the captured image, and
wherein the combining information includes at least one of depth information and transparency information.

3. The image processing apparatus according to claim 1, wherein the CG correction unit calculates a homography matrix based on the motion information on the imaging apparatus, and performs the correction based on transformed coordinates calculated from the homography matrix.

4. The image processing apparatus according to claim 3, wherein the transformed coordinates are coordinate information with accuracy after a decimal point, and the correction by pixel interpolation is a correction using a value obtained by smoothing color information corresponding to the coordinate information as a correction value for pixel interpolation.

5. The image processing apparatus according to claim 3, wherein the transformed coordinates are coordinate information with accuracy after a decimal point, and the correction by pixel replacement is a correction using combining information corresponding to the coordinate information as a correction value for pixel replacement.

6. The image processing apparatus according to claim 3, wherein the transformed coordinates are coordinate information with accuracy after a decimal point, and the correction by pixel replacement is a correction using any one of a minimum value, an intermediate value, a maximum value, and a neighboring value of the combining information corresponding to the coordinate information as a correction value for pixel replacement.

7. The image processing apparatus according to claim 1,
wherein the acquisition unit further acquires depth information on the real world corresponding to the captured image, and
wherein the image processing apparatus further comprises a captured image correction unit configured to separate the captured image into an image channel and a depth information channel, corrects the image channel by pixel interpolation according to the motion information on the imaging apparatus, and correct the depth information channel by pixel replacement according to the motion information on the imaging apparatus, and
wherein the combining unit combines the captured image corrected by the captured image correction unit and the CG image corrected by the CG correction unit.

8. An image processing apparatus comprising:
one or more processors; and
one or more memories coupled to the one or more processors and storing instructions that, when executed by the one or more processors, cause the processor to function as:
an acquisition unit configured to acquire a captured image of a real world captured by an imaging apparatus and depth information on the real world corresponding to the captured image;
a motion acquisition unit configured to acquire motion information on the imaging apparatus in a space of the real world;
a CG generation unit configured to generate a CG image based on the motion information on the imaging apparatus;
a captured image correction unit configured to separate the captured image into an image channel and a depth information channel, correct the image channel by pixel interpolation according to the motion information on the imaging apparatus, and correct the depth information channel by pixel replacement according to the motion information on the imaging apparatus; and
a combining unit configured to combine the captured image corrected by the captured image correction unit and the CG image generated by the CG generation unit.

9. The image processing apparatus according to claim 8,
wherein the captured image correction unit calculates a homography matrix based on the motion information on the imaging apparatus, and
wherein the correction is performed based on transformed coordinates calculated from the homography matrix.

10. The image processing apparatus according to claim 9, wherein the transformed coordinates are coordinate information with accuracy after a decimal point, and the correction by pixel interpolation is a correction using a value obtained by smoothing color information corresponding to the coordinate information as a correction value for pixel interpolation.

11. The image processing apparatus according to claim 9, wherein the transformed coordinates are coordinate information with accuracy after a decimal point, and the correction by pixel replacement is a correction using the depth information corresponding to the coordinate information as a correction value for pixel replacement.

12. The image processing apparatus according to claim 1,
wherein the imaging apparatus includes a sensing unit that senses a motion of the imaging apparatus in a space of the real world, and
wherein the motion acquisition unit acquires motion information on the imaging apparatus, based on sensing information on the sensing unit, and
wherein the image processing apparatus further comprises a position and orientation acquisition unit configured to acquire a position and orientation of the imaging apparatus in the space of the real world, based on motion information on the imaging apparatus,
wherein the CG generation unit generates the CG image based on the position and orientation of the imaging apparatus.

13. The image processing apparatus according to claim 12, wherein the sensing unit is an inertial measurement unit (IMU).

14. An image processing method comprising:
acquiring a captured image obtained by capturing a real world by an imaging apparatus;
acquiring motion information on the imaging apparatus in a space of the real world;
generating a CG image including combining information related to combining with the captured image, based on the motion information on the imaging apparatus;
performing CG correction by separating a CG image including the combining information into an image channel and a combining information channel, correcting the image channel by pixel interpolation according to the motion information on the imaging apparatus, and correcting the combining information channel by pixel replacement according to the motion information on the imaging apparatus; and
combining the captured image and the CG image corrected by the CG correction.

15. A non-transitory computer-readable storage medium storing a program for causing a computer to execute an image processing method, the image processing method comprising:
acquiring a captured image obtained by capturing a real world by an imaging apparatus;
acquiring motion information on the imaging apparatus in a space of the real world;
generating a CG image including combining information related to combining with the captured image, based on the motion information on the imaging apparatus;
performing CG correction by separating a CG image including the combining information into an image channel and a combining information channel, correcting the image channel by pixel interpolation according to the motion information on the imaging apparatus, and correcting the combining information channel by pixel replacement according to the motion information on the imaging apparatus; and
combining the captured image and the CG image corrected by the CG correction.
